(19) United States
(12) Patent Application Publication
(10) Pub. No.: US 2016/0215707 A1
(43) Pub. Date: Jul. 28, 2016

(54) CONTROL DEVICE FOR COMPRESSION-IGNITION TYPE ENGINES

(71) Applicant: Mazda Motor Corporation, Hiroshima (JP)

(72) Inventors: Toru Miyamoto, Higashihiroshima-shi (JP); Masahisa Yamakawa, Hiroshima-shi (JP); Kazuhiro Nagatsu, Hiroshima-shi (JP); Takashi Kaminaga, Hiroshima-shi (JP); Mingzhao Xie, Higashihiroshima-shi (JP); Shintaro Okada, Aki-gun (JP)

(21) Appl. No.: 15/004,149

(22) Filed: Jan. 22, 2016

(30) Foreign Application Priority Data
Jan. 28, 2015 (JP) 2015-014402

(51) Int. Cl. F02D 19/12; F02B 9/02; F02M 25/10

(52) U.S. Cl. CPC F02D 19/12; F02M 25/10; F02B 9/02

(57) ABSTRACT

A control device compression-ignition type engine that compression-ignites an air-fuel mixture in cylinders by introducing ozone into the cylinders at a predetermined operating range is provided. The control device detects a first ignition timing of an air-fuel mixture when introducing an intake of a first ozone concentration into the cylinders, detects a second ignition timing of the air-fuel mixture when introducing an intake of a second ozone concentration that differs from the first ozone concentration, and determines the fuel ignition ability based on a difference between the detected first ignition timing and the detected second ignition timing.

### FIELD OF THE INVENTION

The present invention relates to a control device for compression-ignition type engines, and particularly to a control device for compression-ignition type engines that compression-ignite an air-fuel mixture in cylinders thereof by introducing ozone into the cylinders in a predetermined operating range.

### BACKGROUND ART

In general, for engines using fuel composed of gasoline or mainly gasoline, a spark-ignition system, which ignites with an ignition plug, has been widely adopted. However, recently, a technique has been developed which performs a compression ignition (specifically, so-called HCCI (Homogeneous-Charge Compression Ignition)) in a predetermined operating range by applying a high compression ratio as a geometrical compression ratio of engines from a viewpoint of improving fuel economy, while using fuel composed of gasoline or mainly gasoline.

In the above-described compression-ignition combustion, self-ignition occurs when a temperature of an air-fuel mixture exceeds an ignition temperature because of heat generated by an oxidation reaction (a low-temperature oxidation reaction) of the fuel in the cylinders, and the heat generated by compression of the air-fuel mixture accompanying a piston is raised. The strength of this oxidation reaction of fuel (that is, the activity degree of the oxidation reaction) affects an ignition timing of the air-fuel mixture. In addition, the strength of the oxidation reaction of fuel differs according to a fuel property such as an octane number. Thus, the ignition timing of the air-fuel mixture may vary depending on differences in the fuel properties. Therefore, when the fuel properties are unknown, appropriate combustion position control (for example, controlling ignition at a target ignition timing) is difficult, so that an accidental fire or an abnormal combustion may occur. Accordingly, understanding of an ignition ability of fuel according to the fuel properties in advance is desirable.

A technique to determine the ignition ability of fuel is proposed in, for example, Patent Document 1. In Patent Document 1, in the engine that operates by switching between a spark ignition combustion and a compression-ignition combustion and sets an operating range in which the operation is possible by the compression-ignition combustion, according to a determination result of the fuel ignition ability, a technique which improves the fuel ignition ability by the spark-ignition combustion by providing ozone in cylinders thereof, detects a knocking in this state, and determines the fuel ignition ability according to the detection result, is disclosed.

### RELATED ART

### Patent Document

Patent Document 1: Japanese Unexamined Patent Application Publication 2012-137030

### SUMMARY OF THE INVENTION

### Problems to be Solved by the Invention

However, although the described technique in the above-mentioned Patent Document 1 gradually increases an ozone amount to be introduced in cylinders and determines the fuel ignition ability based on the ozone amount when a detected value of a knock sensor exceeds a threshold value, in this method, since a difference in a period in which knocking occurred (corresponding to the ignition timing) is small due to a difference of a fuel property such as octane number, it is difficult to accurately determine the fuel ignition ability.

The present invention is given for solving the above-mentioned problems of the related art and for a purpose of accurately determining the fuel ignition ability in relation to a compression-ignition type engine that compression-ignites by introducing ozone in cylinders thereof in a predetermined operating range.

### BRIEF SUMMARY OF THE INVENTION

In order to achieve the above-mentioned objective, regarding a control device for a compression-ignition type engine that compression-ignites an air-fuel mixture in cylinders thereof by introducing ozone into the cylinders in a predetermined operating range, the control device of the present invention comprises an ozone amount control module for controlling the ozone amount to be introduced into the cylinders, an ignition timing detection module for detecting an ignition timing of the air-fuel mixture in the cylinders, and an ignition ability determination module for determining a fuel ignition ability based on the ignition timing detected by the ignition timing detection module, wherein the ozone amount control module controls introduction of a second ozone amount, which increases or decreases a first ozone amount, into the cylinders, the ignition ability determination module determines the fuel ignition ability based on a difference between the first ignition timing detected by the ignition timing detection module when the ozone amount control module introduced the first ozone amount into the cylinders and a second ignition timing detected by the ignition timing detection module when the ozone amount control module introduced the second ozone amount into the cylinders. According to the present invention configured in this manner, while the first ignition timing of the air-fuel mixture is detected when an intake including the first ozone amount is introduced into the cylinders, the second ignition timing of the air-fuel mixture is detected when an intake including the second ozone amount, which differs from the first ozone amount, is introduced into the cylinders. Since the fuel ignition ability is determined based on a difference between the detected first ignition timing and the detected second ignition timing, it is possible to accurately determine the fuel ignition ability using the degree of change in the ignition timing corresponding to the change in the ozone amount (specifically, the difference in an advance angle degree of the ignition timing), which appears clearly due to the difference of a fuel property such as the octane number.

In the present invention, preferably, the ozone amount control module introduces the second ozone amount into the cylinders by decreasing the first ozone amount by a predetermined amount after introducing the first ozone amount into the cylinders. According to the present invention configured in this way, the ozone amount control module introduces the second ozone amount into the cylinders (that is, this second ozone amount is smaller than the first ozone amount just by the predetermined amount) by decreasing the first ozone amount by the predetermined amount after introducing the first ozone amount into the cylinders. By applying the amount that can generate a large enough difference between the first ignition timing obtained by applying the first ozone amount and the second ignition timing obtained by the second ozone amount (the difference between the first ozone amount and the second ozone amount) as this predetermined amount, it might be possible to more accurately determine the fuel ignition ability.

In the present invention, preferably, the first ozone amount is the ozone amount that can securely compression-ignite the air-fuel mixture in the cylinders. According to the present invention configured in this way, the compression-ignition of the air-fuel mixture can be appropriately ensured at the start of determination of the fuel ignition ability.

In the present invention, preferably, the ignition ability determination module determines that the larger the difference (the absolute value) between the first ignition timing and the second ignition timing, the more ignition ability the fuel has. According to the present invention configured in this manner, since the relatively large difference appears between the first ignition timing obtained by applying the first ozone amount and the second ignition timing obtained by applying the second ozone amount, according to such a phenomenon, the degree of the ignition ability corresponding to the magnitude of the difference between the first ignition timing and the second ignition timing can be appropriately determined.

In a preferred example, gasoline fuel is supplied to the compression-ignition type engine and the ignition ability determination module determines that the larger the difference between the first ignition timing and the second ignition timing, the smaller the octane number of the fuel.

### Effects of the Invention

According to the present invention, a control device for compression-ignition type engines, which compression-ignite an air-fuel mixture by introducing ozone into cylinders thereof in a predetermined operating range, can accurately determine the fuel ignition ability based on changes in the ignition timing when increasing or decreasing the ozone amount.

### BRIEF DESCRIPTION OF THE DRAWINGS

FIG. 1 is a schematic illustration of the engine, to which a control device for compression-ignition type engines is applied, according to an embodiment of the present invention.

FIG. 2 is a block diagram showing electrical components related to a control device for compression-ignition type engines according to an embodiment of the present invention.

FIG. 3 is a sectional view showing an enlarged combustion chamber of compression-ignition type engines according to an embodiment of the present invention.

FIG. 4 is a schematic diagram exemplifying a configuration of an ozone generator according to an embodiment of the present invention.

FIG. 5 is an explanatory drawing of an operating range of compression-ignition type engines according to an embodiment of the present invention.

FIG. 6 is an explanatory drawing of a fuel ignition ability determination method according to an embodiment of the present invention.

FIG. 7 is a flow chart showing a fuel ignition ability determination process according to an embodiment of the present invention.

### DETAILED DESCRIPTION OF THE EMBODIMENTS

Hereinafter, in reference to the accompanying drawings, a control device for compression-ignition type engines according to an embodiment of the present invention will be described.

[Device Configuration]

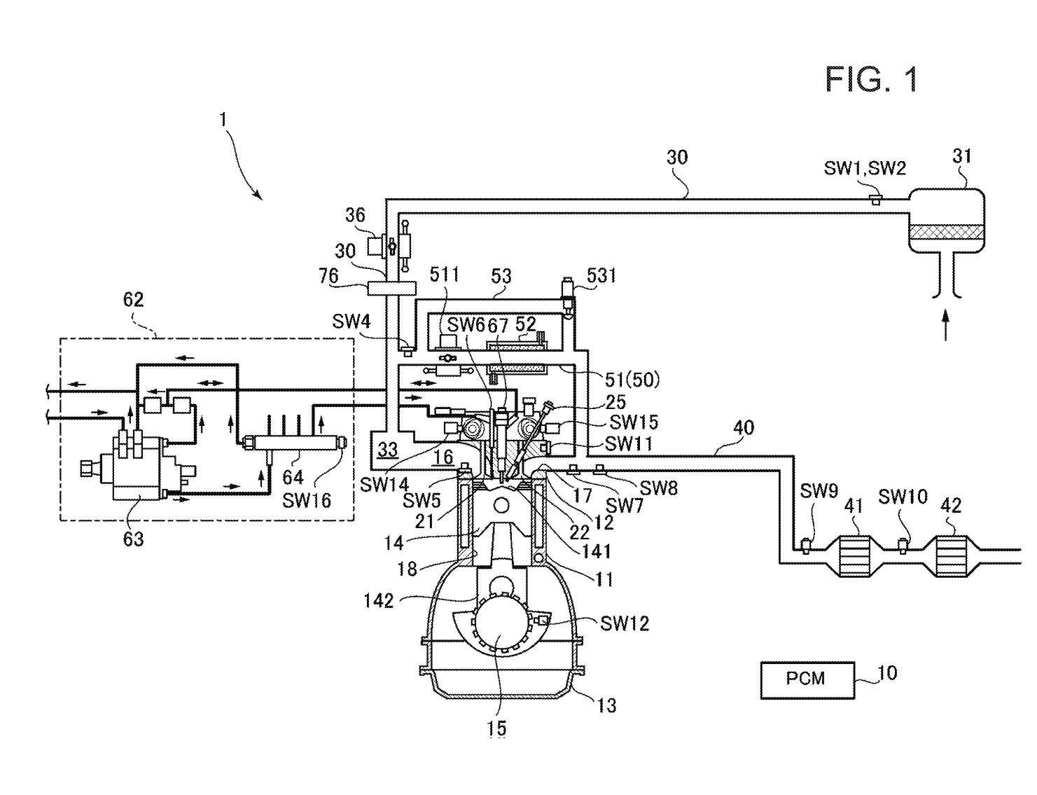

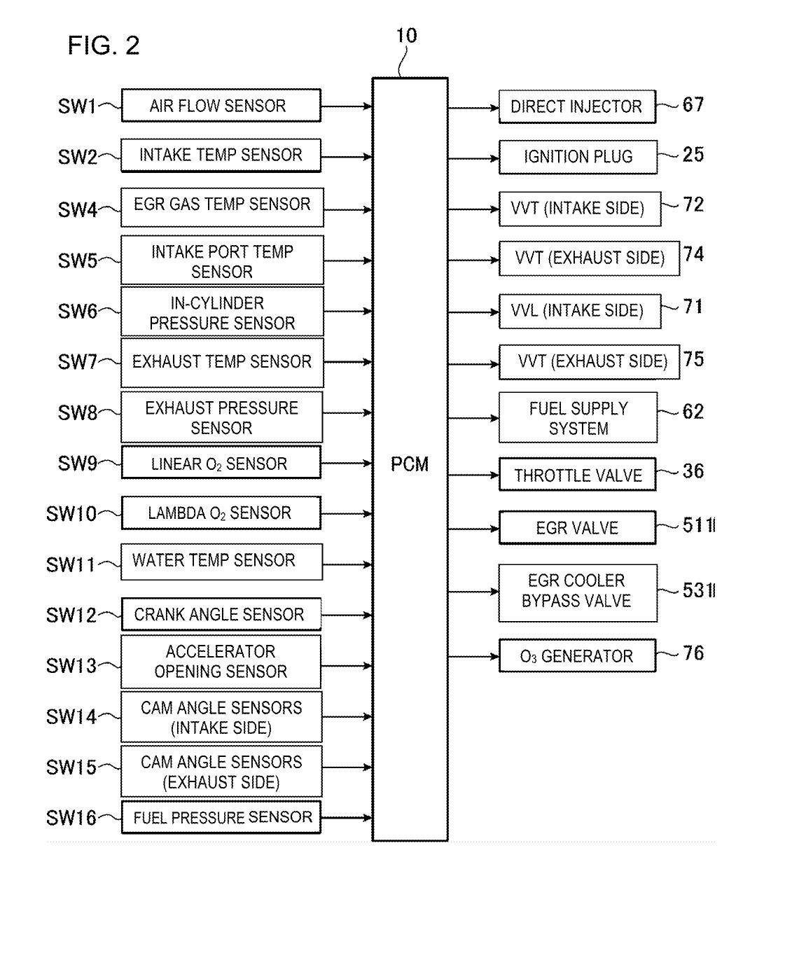

FIG. 1 shows a schematic illustration of an engine 1 (an engine main body) supplied with a control device for a compression-ignition type engine (e.g., the engine 1) according to an embodiment of the present invention, and FIG. 2 is a block diagram showing the control device for the compression-ignition type engine according to the embodiment of the present invention.

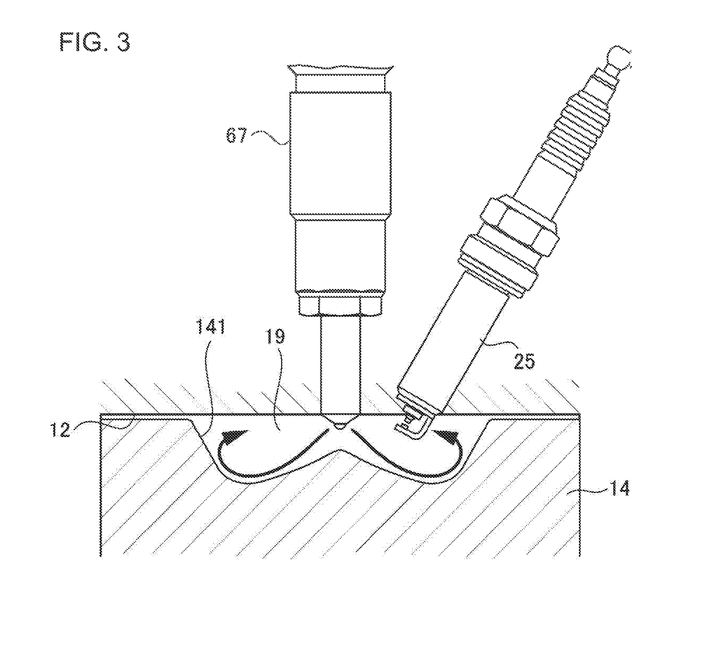

The engine 1 is mounted to a vehicle and a spark-ignition type gasoline engine, to which fuel including at least gasoline is supplied. The engine 1 has a cylinder block 11 where a plurality of cylinders 18 (although only one cylinder is illustrated in FIG. 1, for example, four cylinders are provided in series) are provided, a cylinder head 12 provided on this cylinder block 11, and an oil pan 13 that is provided on the underside of the cylinder block 11 and where lubricant is reserved. A piston 14 that is connected with a crank shaft 15 through a connecting rod 142 is reciprocally fitted and inserted into each cylinder 18. On the top surface of the piston 14, as shown enlarged in FIG. 3, a cavity 141 like a reentrant type of a diesel engine is formed. The cavity 141 is faced toward an injector 67 which is described later, when the piston 14 is located near a compression top dead center. The cylinder head 12, the cylinders 18, and the piston 14 having the cavity 141 define a combustion chamber 19. Moreover, the shape of the combustion chamber 19 is not limited to the illustrated shape. For example, the shape of the cavity 141, the shape of a top surface of the piston 14, the shape of a ceiling part of the combustion chamber 19 and the like can be appropriately modified.

This engine 1 is set to be the relatively high geometrical compression ratio exceeding 15 for the purpose of improving the theoretical thermal efficiency or the stabilizing compression-ignition combustion to be described later. Moreover, the geometrical compression ratio might be appropriately set in a range of about 15 or more and 20 or less.

While an intake port 16 and an exhaust port 17 are formed by each cylinder 18 on the cylinder head 12, an intake valve 21 and an exhaust valve 22, which opens and closes an opening of the combustion chamber 19 side, are provided on the intake port 16 and the exhaust port 17 respectively.

Within a valve operating system that drives each intake valve 21 and exhaust valve 22, for example, a hydraulic operation type variable mechanism (refer to FIG. 2; hereinafter, VVL (Variable Valve Lift)) 71 which switches an operation mode of the exhaust valve 22 between a normal mode and a special mode, and a phase variable mechanism (hereinafter, VVT (Variable Valve Timing)) 75 which can change the rotational phase of an exhaust camshaft corresponding to a crank shaft 15, are provided on the exhaust side. Although a detailed illustration of the configuration is omitted, VVL 71 is configured by including a lost motion mechanism that selectively transmits to the exhaust valve 22 the operating state of either one of two kinds of cams, which have different cam profiles and are a first cam having one cam ridge and a second cam having two cam ridges. When transmitting the operating state of the first cam to the exhaust valve 22, the exhaust valve 22 is operated by the normal mode, which opens a valve just once during the exhaust stroke, whereas, when transmitting the operating state of the second cam to the exhaust valve 22, the exhaust valve 22 is operated by the special mode, which performs a so-called open-twice exhaust, such that it opens the valve during the exhaust stroke and also opens the valve during the intake stroke. The normal mode and the special mode of VVL 71 are switched according to the operation state of the engine. Specifically, the special mode is used for control related to an internal EGR. Moreover, a valve operating system of an electromagnetic driving type, which drives the exhaust valve 22 by an electromagnetic actuator, might be adopted.

In addition, an execution of the internal EGR is not implemented by only the open-twice exhaust. For example, an internal EGR control might be performed by the double opening of the intake that opens the intake valve 21 twice, and also the internal EGR control might be performed by reserving the burnt gas in the cylinders 18 by providing a negative overlap period that closes both the intake valve 21 and the exhaust valve 22 at the exhaust stroke or the intake stroke.

A well-known hydraulic, electromagnetic, or mechanical structure might be appropriately applied for VVT 75, and a detailed configuration is omitted from the figures. The valve opening period and valve closing period of the exhaust valve 22 can be continuously changed by the VVT 75 within a predetermined range.

Like the valve operating system on the exhaust side having the VVL 71 and the VVT 75, as shown in FIG. 2, a VVL 74 and a VVT 72 are provided on the intake side. However, the VVL 74 on the intake side differs from the VVL 71 on the exhaust side. The VVL 74 on the intake side is configured by including a lost motion mechanism that selectively transmits the operating state of either one of two kinds of cams having different cam profiles, which are a large lift cam, which makes the lift amount of the intake valve 21 relatively large, and a small lift cam, which makes the lift amount of the intake valve 21 relatively small, to the intake valve 21. When the VVL 74 transmits the operating state of the large lift cam to the intake valve 21, the intake valve 21 opens the valve by a relatively large lift amount and also the valve opening period lengthens, whereas when the VVL 74 transmits the operating state of the small lift cam to the intake valve 21, the intake valve 21 opens the valve by a relatively small lift amount, and also the valve opening period shortens. The large lift cam and the small lift cam are set to switch with the same valve closing period or valve opening period.

Like the VVT 75 on the exhaust side, a well-known hydraulic, electromagnetic, or mechanical structure might be appropriately applied for the VVT 72 on the intake side, and the detailed configuration is omitted from the figures. The valve opening period and valve closing period of the intake valve 21 can also be continuously changed by the VVT 72 within a predetermined range. Moreover, instead of applying the VVL 74 on the intake side, only the VVT 72 may be applied, and only the valve opening period and valve closing period of the intake valve 21 may be changed.

A (direct injection) injector 67, which directly injects fuel into the cylinders 18, is also provided on the cylinder head 12 for each cylinder 18. As shown enlarged in FIG. 3, the injector 67 is provided so that its nozzle port faces into the combustion chamber 19 from a central position in a ceiling surface of the combustion chamber 19. The injector 67 directly injects fuel into the combustion chamber 19 at the injection timing set according to the operation state of the engine 1 and by the amount according to the operation state of the engine 1. In this example, although the detailed illustration is omitted from the figures, the injector 67 is a multi-nozzle-ports-type injector having a plurality of nozzle ports. According to this, the injector 67 injects fuel so that fuel sprays radiate out from a center part of the combustion chamber 19. As shown by the arrows in FIG. 3, the fuel sprays, which are injected so as to radiate out from the center part of the combustion chamber 19 at the timing of the piston 14 which is located near the compression top dead center, flow along a wall surface of the cavity 141 formed on a piston top surface. In other words, the cavity 141 is formed so as to store therein the fuel sprays, which are injected at the timing of the piston 14 which is located near the compression top dead center. This combination of the multi-nozzle-ports-type injector 67 with the cavity 141 shortens the air-fuel mixture forming period after injecting fuel and also is a favorable configuration to shorten the combustion period. Moreover, the injector 67 is not limited to the multi-nozzle-ports-type injector, and an outward-opening valve-type injector might be applied.

A fuel tank outside of the figure and the injector 67 are connected to one another by a fuel supply passage. On this fuel supply passage, a fuel pump 63 and a common rail 64 are included, and a fuel supply system 62, which can supply fuel to the injector 67 at a relatively high fuel pressure, is interposed. The fuel pump 63 force-feeds fuel from the fuel tank to the common rail 64, and the common rail 64 can store the force-fed fuel at a relatively high fuel pressure. By opening the valve with the injector 67, the fuel being stored in the common rail 64 is injected from a nozzle port of the injector 67. At this point, although not shown in the figure, the fuel pump 63 is a plunger-type pump and is driven by the engine 1. The fuel supply system 62 configured including this engine-driven pump can supply fuel with 30 MPa and higher fuel pressure to the injector 67. The fuel pressure might be set in a range of up to 120 MPa. The fuel pressure to be supplied to the injector 67, as described later, might be changed according to the operation state of the engine 1. In addition, the fuel supply system 62 is not limited to this configuration.

As shown in FIG. 3, an ignition plug 25, which forcibly ignites the air-fuel mixture in the combustion chamber 19, is also provided on the cylinder head 12. The ignition plug 25 in this example is arranged through the cylinder head 12 so as to extend diagonally downward from the exhaust side of the engine 1. As shown in FIG. 3, a tip end of the ignition plug 25 is arranged facing toward the cavity 141 of the piston 14 located on the compression top dead center.

On one side of the engine 1, as shown in FIG. 1, an intake passage 30 is connected so as to communicate with the intake port 16 of each cylinder 18. On the other hand, on the other side of the engine 1, an exhaust passage 40, which exhausts the burnt gas (exhaust gas) from the combustion chamber 19 of each cylinder 18, is connected.

An air cleaner 31 for filtering the intake air is provided on an upstream end part of the intake passage 30, and a throttle valve 36 for adjusting the intake air amount to each cylinder 18 is provided on a downstream side thereof. Moreover, a surge tank 33 is provided near the downstream end of the intake passage 30. The downstream end of the intake passage 30, which is downstream of this surge tank 33, is an independent passage branching to each cylinder 18, and these downstream ends of each independent passage are connected to the intake port 16 of each cylinder 18 respectively.

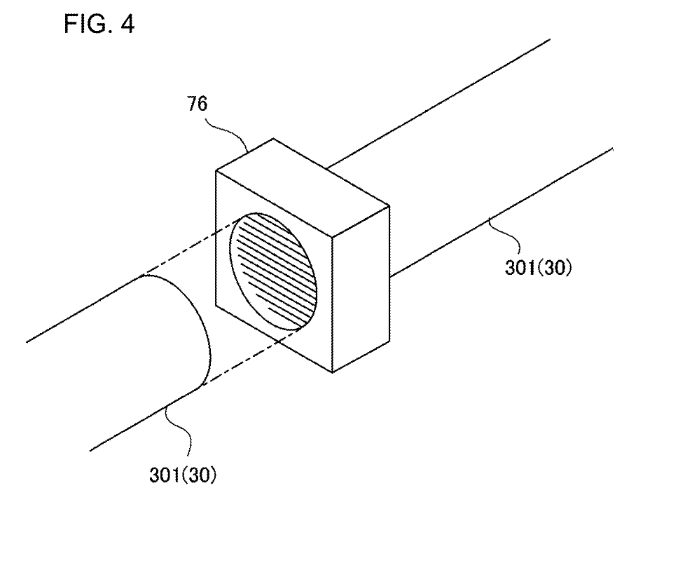

In addition, between the throttle valve 36 and the surge tank 33 on the intake passage 30, an ozone generator (03 generator) 76, which adds ozone to fresh air being introduced to the cylinders 18, is interposed. For example, as shown in FIG. 4, on a cross-section of an intake pipe 301, the ozone generator 76 is configured with a plurality of electrodes disposed in parallel at a predetermined distance in a vertical or a lateral direction. The ozone generator 76 generates ozone by silent discharge with oxygen included in the intake as a source gas. Thus, by applying high-frequency alternating current voltages from the power source outside of the figure to the electrode, the silent discharge is generated at discharge intervals and the air passed therethrough (that is, through the intake) is ozonized. The intake provided with ozone in this way is introduced through an intake manifold from the surge tank 33 into each cylinder 18. By changing the application modes of voltage to the electrode(s) of the ozone generator 76, and/or changing the number of electrodes to which voltage is applied, an ozone concentration in the intake after passing though the ozone generator 76 can be adjusted. As described later, a PCM 10 adjusts the ozone concentration in the intake to be introduced into the cylinders 18 through these controls to the ozone generator 76.

A part of the upstream side of the exhaust passage 40 is configured by an exhaust manifold having the independent passage, which is branched to each cylinder 18 and connected to the outside end of the exhaust port 17, and a collecting part, at which s each of the independent passages are collected together. A direct catalyst 41 and an underfoot catalyst 42 are each connected to an exhaust passage 40 downstream of the exhaust manifold as an exhaust purification device to purify harmful components in the exhaust gas. The direct catalyst 41 and the underfoot catalyst 42 are each configured with a cylindrical case, and, for example, a three-way catalyst provided on the flow passage into the case thereof.

A part between the surge tank 33 and the throttle valve 36 on the intake passage 30 and a part further upstream of the direct catalyst 41 on the exhaust passage 40 are connected through an EGR passage 50 to return a part of the exhaust gas to the intake passage 30. This EGR passage 50 is configured by including a main passage 51, on which an EGR cooler 52 to cool the exhaust gas by engine coolant is provided, and an EGR cooler bypass passage 53 to bypass the EGR cooler 52. An EGR valve 511 to adjust a recirculation amount of the exhaust gas to the intake passage 30 is provided on the main passage 51, and an EGR cooler bypass valve 531 to adjust a flow amount of the exhaust gas circulating the EGR cooler bypass passage 53 is provided on the EGR cooler bypass passage 53.

The engine 1 is controlled by a powertrain control module 10 (hereinafter, PCM). The PCM 10 is configured with a microprocessor having a CPU, memory including non-volatile memory, a counter timer group, an interface, and a path connecting these units. This PCM 10 constitutes a controller.

As shown in FIGS. 1 and 2, detection signals of each sensor SW1, SW2, and SW4 to SW16 are input into the PCM 10. Specifically, detection signals of an air flow sensor SW1 which detects a flow amount of fresh air, detection signals of an intake temperature sensor SW2 which detects a temperature of fresh air, detection signals of an EGR gas temperature sensor SW4 which is provided near a connecting part with the intake passage 30 on the EGR passage 50 and detects a temperature of external EGR gas, detection signals of an intake port temperature sensor SW5 which is mounted on the intake port 16 and detects a temperature of the intake just before flowing into the cylinders 18, detection signals of in-cylinder pressure sensors SW6 which are mounted on each cylinder head 12 and detect a pressure in the cylinders 18, detection signals of an exhaust temperature sensor SW7 and an exhaust pressure sensor SW8 which are provided near the connecting part of the EGR passage 50 on the exhaust passage 40 and detect an exhaust temperature and an exhaust pressure, respectively, detection signals of a linear O₂ sensor SW9 which is provided on the upstream side of the direct catalyst 41 and detects an oxygen concentration in the exhaust, detection signals of a lambda O₂ sensor SW10 which is provided between the direct catalyst 41 and the underfoot catalyst 42 and detects the oxygen concentration in the exhaust, detection signals of a water temperature sensor SW11 which detects a temperature of the engine coolant, detection signals of a crank angle sensor SW12 which detects a rotation angle of the crank shaft 15, detection signals of an accelerator opening sensor SW13 which detects an accelerator opening degree corresponding to an operation amount of an accelerator pedal the vehicle (not shown), detection signals of cam angle sensors SW14 and SW15 on the intake side and the exhaust side, and detection signals of a fuel pressure sensor SW16 which is mounted on the common rail 64 of the fuel supply system 62 and detects a fuel pressure to be supplied to the injector 67, are input into the PCM 10.

The PCM 10 detects the state of the engine 1 or the vehicles by various computing methods based on these detection signals, and outputs control signals to the injector 67, the ignition plug 25, the VVT 72 and VVL 74 on the intake valve side, the VVT 75 and the VVL 71 on the exhaust valve side, the fuel supply system 62, as well as actuators of each valve (the throttle valve 36, the EGR valve 511, the EGR cooler bypass valve 531) and the ozone generator 76 according to this detection. In this way, the PCM 10 operates the engine 1. Although the details will be described later, the PCM 10 is equivalent to the control device for compression-ignition type engines according to the present invention and executes software, such as an ozone amount control module, an ignition timing detection module, and an ignition ability determination module, which are stored in the non-volatile memory.

[Operating Range]

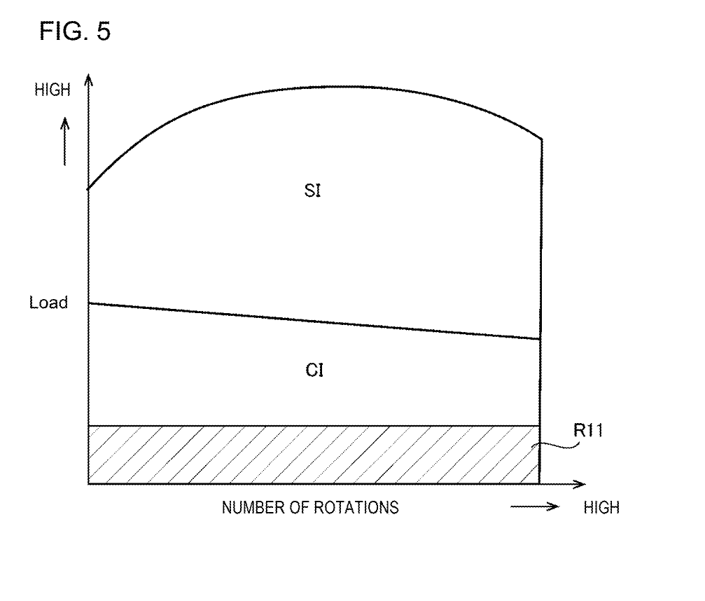

Next, in reference to FIG. 5, an operating range of compression-ignition type engines according to an embodiment of the present invention will be described. FIG. 5 shows an example of an operation control map of the engine 1. In order to improve the fuel economy or the exhaust emission performance, this engine 1 performs compression-ignition combustion in which combustion is performed by a compression self-ignition without performing ignition by an ignition plug 25 in a low load range that has a relatively low engine load. However, as the load of the engine 1 becomes high, the combustion by the compression-ignition combustion becomes too steep, so that a problem such as combustion noises and the like might be caused. Therefore, this engine 1 stops the compression-ignition combustion and switches to the forced ignition combustion (here, a spark ignition combustion) using the ignition plug 25 in a high load range that has a relatively high engine load. In this way, this engine 1 is configured so as to switch to a CI (Compression-Ignition) mode to perform the compression-ignition combustion and a SI (Spark Ignition) mode to perform the spark-ignition combustion according to the operation state of the engine 1, especially the load of the engine 1. However, a boundary of switching the modes is not limited to the example in the figure.

Especially, in the present embodiment, in an area R11 equivalent to the low load range area in the CI mode, in order to improve the ignition ability and stability of the compression-ignition combustion, ozone generated by the ozone generator 76 is introduced into the cylinders 18 so as to facilitate the low-temperature oxidation reaction of fuel. In addition, the internal EGR gas having a relatively high temperature is introduced into the cylinders 18 by turning on the VVL 71 on the exhaust side and performing the open-twice exhaust that opens the exhaust valve 22 during the intake stroke so as to raise the compression end temperature in the cylinders 18. Moreover, in the area R11, in order to form a homogeneous air-fuel mixture, during a period at least from the intake stroke to the intermediate stage of the compression stroke, the injector 67 injects fuel into the cylinders 18. In this case, in the intake stroke and the compression stroke, fuel might be split-injected.

In the CI mode, the ozone introduction into the cylinders 18 might be stopped in the higher load range area than the area R11. In addition, since the temperature in the cylinders 18 becomes high, while reducing the internal EGR gas amount in order to restrain pre-ignition, the external EGR gas which is cooled by going through the EGR cooler 52 is introduced into the cylinders 18. Moreover, with this temperature control in the cylinders 18, while avoiding abnormal combustion such as pre-ignition, the fuel is injected into the cylinders 18 during a period at least from the latter stage of the compression stroke to the early stage of the expansion stroke by drastically high fuel pressure so as to stabilize the compression-ignition combustion.

[Ignition Ability Detection]

Next, a fuel ignition ability determination method according to an embodiment of the present invention will be described.

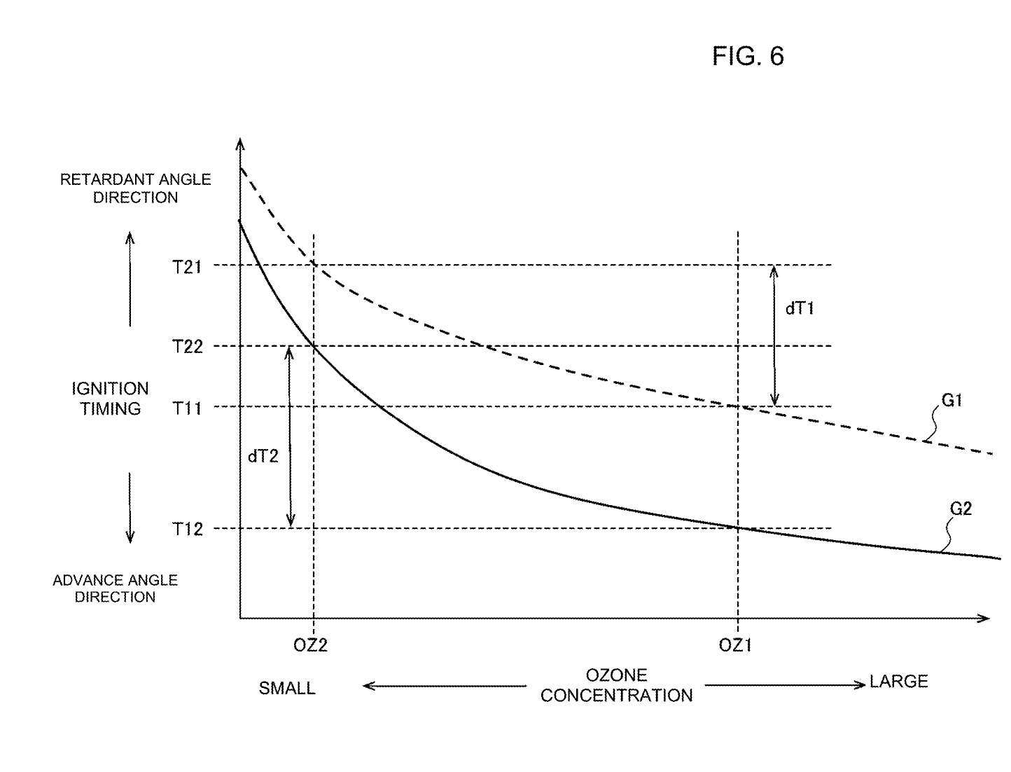

First, in reference to FIG. 6, a basic concept of the fuel ignition ability determination method according to the embodiment of the present invention will be described. FIG. 6 shows an ozone concentration on a horizontal axis, which is included in the intake introduced into the cylinders 18, and ignition timing of the air-fuel mixture on a vertical axis. Moreover, the change in ozone concentration shown on the horizontal axis is achieved by controlling the ozone generator 76 with the PCM 10. This ozone concentration unequivocally corresponds to the ozone amount included in the intake to be introduced into the cylinders 18. Further, the ignition timings shown on the vertical axis are equivalent to the advance angle degree of the ignition timing after the top dead center, and the ignition timing is advanced by moving to the lower side. In this case, the more the ignition timing moves to the advance angle side, the higher the fuel ignition ability becomes.

In FIG. 6, the graph G1 shows a relationship between the ozone concentration and the ignition timing when using the fuel having a relatively high octane number (for example, 100 RON), and the graph G2 shows a relationship between the ozone concentration and the ignition timing when using the fuel having a relatively lower octane number (for example, 90 RON) than that of the fuel in graph G1. From both graphs G1 and G2, the higher the ozone concentration is, the more the ignition timing is advanced. This means that the low-temperature oxidation reaction progresses more easily when the ozone concentration becomes high (that is the low-temperature oxidation reaction becomes activated and the ignition ability is improved). Moreover, both graphs G1 and G2 show that when the ozone concentration rises above a certain level, even though the ozone concentration becomes high, the ignition timing becomes substantially constant with little advance (that is, the ignition timing reaches a saturation point).

In addition, a comparison of the graph G1 and the graph G2 shows that the degree of change in the ignition timing corresponding to the change in ozone concentration is larger when using the fuel having the low octane number than when using the fuel having the high octane number; specifically, the degree of change toward the advance angle side of the ignition timing according to the increase of the ozone concentration is large. This is caused by the property of the fuel having the low octane number that makes the low-temperature oxidation reaction progress more, and it easily self-ignites more than the fuel having the high octane number.

In the present embodiment, as shown in FIG. 6, using the degree of change in the ignition timing (that is, the difference in the advance angle degree of the ignition timing) corresponding to the change in ozone concentration due to the difference of the fuel octane number, the fuel ignition ability is detected. Specifically, in the present embodiment, the PCM 10 introduces the intake of a second ozone concentration (equivalent to a second ozone amount) that is lower than a first ozone concentration into the cylinders 18 after introducing the intake of the first ozone concentration (equivalent to a first ozone amount) into the cylinders 18 by controlling the ozone generator 76 in the area R11 (refer to FIG. 5) equivalent to the low load range area in the CI mode. Then, in this way, the PCM 10 determines the fuel ignition ability based on the difference between the first ignition timing when applying the first ozone concentration and the second ignition timing when applying the second ozone concentration. For example, the PCM 10 detects the ignition timing of the air-fuel mixture based on the change of the detection signals input from the in-cylinder pressure sensor SW6. In addition, hereinafter, the first ozone concentration is suitably written as “the first ozone concentration OZ1,” the second ozone concentration is suitably written as “the second ozone concentration OZ2,” the first ignition timing when applying the first ozone concentration OZ1 is suitably written as “the first ignition timing T1,” the second ignition timing when applying the second ozone concentration OZ2 is suitably written as “the second ignition timing T2,” and the difference between the second ignition timing T2 and the first ignition timing T1 is suitably written as “difference dT.”

In reference to FIG. 6, a concrete example of the fuel ignition ability determination method will be described. As shown in FIG. 6, the PCM 10 controls the ozone generator 76 so as to introduce the intake of the second ozone concentration OZ2, which is smaller than the first ozone concentration OZ1 only by a predetermined value, into the cylinders 18 after introducing the intake of the first ozone concentration OZ1 into the cylinders 18. For example, the PCM 10 applies a value as the predetermined value, which can make a large enough difference (the difference between the first ozone concentration OZ1 and the second ozone concentration OZ2) between the first ignition timing T1 obtained when applying the first ozone concentration OZ1 and the second ignition timing T2 obtained when applying the second ozone concentration OZ2.

In the case of using the fuel having the high octane number as shown in graph G1, the PCM 10 detects “T11” as the first ignition timing T1 when applying the first ozone concentration OZ1 and also detects “T21” as the second ignition timing T2 when applying the second ozone concentration OZ2 based on the detection signals that were input from the in-cylinder pressure sensor SW6. Then, the PCM 10 obtains “dT1” as the difference dT between the detected second ignition timing T21 and the detected first ignition timing T11 (dT1=T21−T11).

On the other hand, in the case of using the fuel having the low octane number as shown in graph G2, the PCM 10 detects “T12” as the first ignition timing T1 when applying the first ozone concentration OZ1 and also detects “T22” as the second ignition timing T2 when applying the second ozone concentration OZ2 based on the detection signals that were input from the in-cylinder pressure sensor SW6. Then, the PCM 10 obtains “dT2” as the difference dT between the detected second ignition timing T22 and the detected first ignition timing T12 (dT2=T22−T12). In this manner, the difference dT2 obtained when using the fuel having the low octane number is larger than the difference dT1 obtained when using the fuel having the high octane number. The reason is as described above.

After this, the PCM 10 determines the fuel ignition ability based on the magnitude of difference dT by obtaining the difference dT between the second ignition timing T2 and the first ignition timing T1 by the above-described procedures. Specifically, the PCM 10 determines that the larger the difference dT between the second ignition timing T2 and the first ignition timing T1 becomes, the higher ignition ability the fuel has. Moreover, the PCM 10 can presume the octane number of fuel based on the difference between the second ignition timing T2 and the first ignition timing T1. In that case, if a corresponding map of the octane number according to the difference dT between the second ignition timing T2 and the first ignition timing T1 is made in advance, by referring such the map, the fuel octane number corresponding to the difference dT between the second ignition timing T2 and the first ignition timing T1 obtained this time can be determined.

At this point, the ozone concentration, which can securely compression-ignite the air-fuel mixture in the cylinders 18, or, specifically, the ozone concentration at which the ignition timing is hardly advanced even though the ozone concentration is raised (that is, the ozone concentration that the ignition timing begins to reach a saturation point), might be applied as the first ozone concentration OZ1 to detect the first ignition timing T1. In doing so, while appropriately ensuring the compression-ignition of the air-fuel mixture in the cylinders 18 at the start of determination of the fuel ignition ability, a large enough difference between the first ignition timing T1 and the second ignition timing T2 is generated by decreasing the ozone concentration from the first ozone concentration OZ1 to the second ozone concentration OZ2 after this, so that the appropriate determination of the fuel ignition ability is possible. Moreover, as described above, the reason for applying the ozone concentration at which the ignition timing begins to reach a saturation point to the first ozone concentration OZ1 is that the ignition timing is not changed even after applying the ozone concentration which is larger than the ozone concentration OZ1, because the ignition timing is hardly changed toward the advance angle side. In this way, by limiting the first ozone concentration OZ1 to the ozone concentration at which the ignition timing begins to reach a saturation point, it is possible to restrain the ozone concentration from being raised wastefully and to restrain the ozone generator 76 from consuming power wastefully.

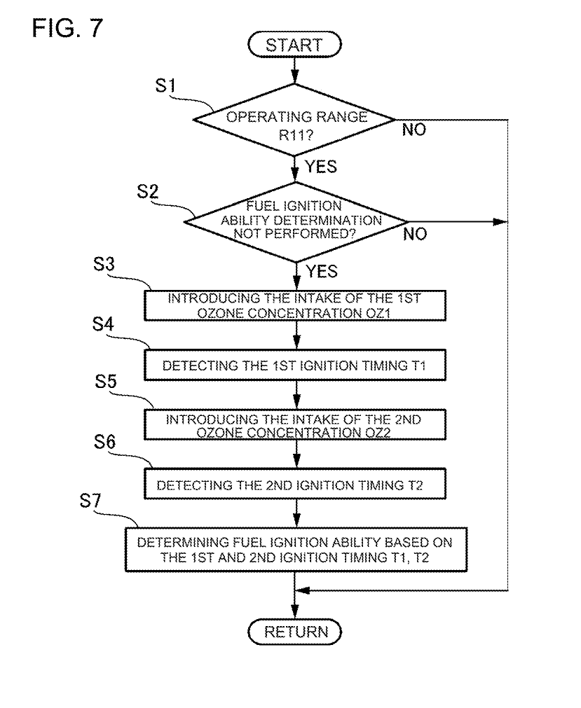

Next, with reference to FIG. 7, a fuel ignition ability determination process according to the embodiment of the present invention will be described. FIG. 7 is a flowchart showing a fuel ignition ability determination process according to the embodiment of the present invention. This flow is performed repeatedly at a given cycle by the PCM 10 when operating the vehicle.

First of all, in Step S1, the PCM 10 determines whether or not the operating range of the engine 1 is in the area R11 (refer to FIG. 5) equivalent to the low load range area of the CI mode. This means that it determines whether or not it is the operating range at which the ozone generated by the ozone generator 76 should be introduced into the cylinders 18, or, in other words, whether or not it is the operating range at which the fuel ignition ability determination according to the present embodiment is performed. During the determination of Step S1, if the operating range of the engine 1 is in the area R11 (Step S1: Yes), the process proceeds to Step S2, and if the operating range of the engine 1 is not in the area R11 (Step S1: No), the process is terminated.

In Step S2, the PCM 10 determines whether or not the fuel ignition ability determination has been performed yet. Specifically, the PCM 10 determines whether the fuel ignition ability determination has been performed yet after refueling. The fuel ignition ability determination is supposed to be performed when refueling, so once the fuel ignition ability determination has been performed after refueling, the ignition ability determination is not needed again, and the determination will not be performed. Moreover, the fuel ignition ability determination might be performed every time the engine 1 is started. During Step S2, when the fuel ignition ability determination has not been performed yet (Step S2: Yes), the process proceeds to Step S3, and when the fuel ignition ability determination has already been performed (Step S2: No), the process is terminated.

At Step S3, the PCM 10 controls the ozone generator 76 so as to introduce the intake of the predetermined first ozone concentration OZ1 into the cylinders 18. After that, at Step S4, the PCM 10 detects the first ignition timing T1 when the intake of the first ozone concentration OZ1 is introduced into the cylinders 18 based on the detection signals input from the in-cylinder pressure sensor SW6. At this time, the PCM 10 detects, as the first ignition timing T1, a timing at which the in-cylinder pressure corresponding to the detection signals input from the in-cylinder pressure sensor SW6 becomes the predetermined pressure or more.

After that, at Step S5, the PCM 10 controls the ozone generator 76 so as to introduce the intake of the predetermined second ozone concentration OZ2 (less than the first ozone concentration OZ1) into the cylinders 18. In this case, the PCM 10 controls the ozone generator 76 so as to reduce the ozone concentration of the intake to be introduced into the cylinders 18. After that, at Step S6, the PCM 10 detects the second ignition timing T2 when the intake of the second ozone concentration OZ2 is introduced into the cylinders 18 based on the detection signals input from the in-cylinder pressure sensor SW6. At this time, the PCM 10 detects, as the second ignition timing T2, a timing at which the in-cylinder pressure corresponding to the detection signals input from the in-cylinder pressure sensor SW6 becomes the predetermined pressure or more.

After that, at Step S7, the PCM 10 determines the fuel ignition ability based on the first ignition timing T1 detected at Step S4 and the second ignition timing T2 detected at Step S6. Specifically, the PCM 10 calculates the difference dT (dT=T2−T1) between the second ignition timing T2 and the first ignition timing T1 and determines the fuel ignition ability based on the magnitude of this difference dT. In one example, the PCM 10 determines that the larger the difference dT between the second ignition timing T2 and the first ignition timing T1 becomes, the higher ignition ability the fuel has. In another example, the PCM 10 determines that the fuel ignition ability is high when the difference dT between the second ignition timing T2 and the first ignition timing T1 is equal to or above the predetermined value, and the fuel ignition ability is low when the difference dT between the second ignition timing T2 and the first ignition timing T1 is lower than the predetermined value.

[Effects]

According to the above-described control device for compression-ignition type engines according to the embodiment of the present invention, while the first ignition timing T1 is detected when the intake of the first ozone concentration OZ1 is introduced into the cylinders 18, the second ignition timing T2 is detected when the intake of the second ozone concentration OZ2, which differs from the first ignition timing T1, is introduced into the cylinders 18. Since the fuel ignition ability is determined based on the difference dT between the detected first ignition timing T1 and the detected second ignition timing T2, it is possible to accurately determine the fuel ignition ability by using the degree of change in the ignition timing corresponding to the change in the ozone concentration (that is, the difference in the advance angle degree of the ignition timing), which appears clearly due to the difference in a fuel property such as the octane number.

According to the present embodiment, since the ignition ability determination is performed by applying the second ozone concentration OZ2 that reduced the first ozone concentration OZ1 by the predetermined amount after applying the first ozone concentration OZ1 that can securely compression-ignite the air-fuel mixture in the cylinders 18, while appropriately ensuring the compression-ignition of the air-fuel mixture at the start of the fuel ignition ability determination, by generating a large enough difference dT between the first ignition timing T1 and the second ignition timing T2, the appropriate determination of fuel ignition ability is possible.

[Variations]

Although the PCM 10 detects the ignition timing of the air-fuel mixture based on the detection signals of the in-cylinder pressure sensor SW6 in the above-described embodiment, in another example, the ignition timing of the air-fuel mixture might be detected based on the detection signals of an ion current sensor (for example, like the one that is mounted on the ignition plug 25) that is mounted on the cylinders 18 or the crank angle sensor SW12 instead of the in-cylinder pressure sensor SW6.

Moreover, although the fuel ignition ability is determined by reducing the ozone concentration from the first ozone concentration OZ1 to the second ozone concentration OZ2 in the above-described embodiment, in another example, the fuel ignition ability might be determined by increasing the ozone concentration from the second ozone concentration OZ2 to the first ozone concentration OZ1. In this case, if the difference between the first ozone concentration OZ1 and the second ozone concentration OZ2 is sufficiently ensured, there will also be a large enough difference dT between the first ignition timing T1 and the second ignition timing T2 detected when applying these concentrations, so that the fuel ignition ability can be determined appropriately.

Moreover, in the above-described embodiment, although the fuel ignition ability is determined by changing the ozone concentration of the intake to be introduced into the cylinders 18, doing so is the same as determining the fuel ignition ability by changing the ozone amount to be introduced into the cylinders 18.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof, are therefore intended to be embraced by the claims.

### LIST OF REFERENCE CHARACTERS

1 Engine (Engine main body)
10 PCM
18 Cylinders
25 Ignition plug
30 Intake passage
76 Ozone generator (O₃ generator)
SW6 In-cylinder pressure sensor

1. A control device for a compression-ignition type engine that compression-ignites an air-fuel mixture in cylinders thereof by introducing ozone into the cylinders at a predetermined operating range, the control device comprising:
an ozone amount control module for controlling an ozone amount to be introduced into cylinders,
an ignition timing detection module for detecting a self-ignition timing of an air-fuel mixture in the cylinders, and
an ignition ability determination module for determining a fuel ignition ability based on an ignition timing detected by the ignition timing detection module,
wherein the ozone amount control module controls the introduction of a second ozone amount, which is increased or decreased compared to a first ozone amount, into the cylinders after introducing the first ozone amount into the cylinders, and the ignition ability determination module determines a fuel ignition ability based on a corresponding difference between a first self-ignition timing detected by the ignition timing detection module when the ozone amount control module introduced the first ozone amount into the cylinders and a second self-ignition timing detected by the ignition timing detection module when the ozone amount control module introduced the second ozone amount into the cylinders.

2. The control device for the compression-ignition type engine according to claim 1,
wherein the ozone amount control module introduces the second ozone amount into the cylinders by decreasing the first ozone amount by a predetermined amount after introducing the first ozone amount into the cylinders.

3. The control device for the compression-ignition type engine according to claim 2,
wherein the first ozone amount is the ozone amount that can securely compression-ignite the air-fuel mixture in the cylinders.

4. The control device for the compression-ignition type engine according to claim 1,
wherein the ignition ability determination module determines that the larger the difference between the first ignition timing and the second ignition timing is, the more ignition ability the fuel has.

5. The control device for the compression-ignition type engine according to claim 1,
wherein a gasoline fuel is supplied to the compression-ignition type engine, and the ignition ability determination module determines that the larger the difference between the first ignition timing and the second ignition timing is, the smaller the octane number the fuel has.
